(19) United States
(12) Patent Application Publication
(10) Pub. No.: US 2025/0278492 A1
(43) Pub. Date: Sep. 4, 2025

(54) METHOD FOR VERIFYING SECURITY AND/OR SAFETY OF A TECHNICAL SYSTEM

(71) Applicant: Robert Bosch GmbH, Stuttgart (DE)

(72) Inventors: Dongjun Cai, Singapore (SG); Liang Lionel Wong You, Singapore (SG)

(21) Appl. No.: 19/066,999

(22) Filed: Feb. 28, 2025

(30) Foreign Application Priority Data
Mar. 4, 2024 (DE) 10 2024 201 985.2

(51) Int. Cl. G06F 21/57

(52) U.S. Cl. CPC G06F 21/577; G06F 2221/034

(57) ABSTRACT

A method for verifying security and/or safety of a technical system. The method includes receiving architectural information about the technical system, wherein the architectural information includes information about a hierarchy of the functional parts of the technical system, extracting keywords identifying functional parts of the technical system and, for each keyword, hierarchy information specifying a position of the functional part identified by the keyword in a hierarchy of the functional parts of the technical system, generating, for each keyword, an embedding of the keyword and its hierarchy information, feeding the generated embeddings to a machine learning model trained to generate Threat Analysis and Risk Assessment information for the technical system from the embeddings and verifying security and/or safety of the technical system using the Threat Analysis and Risk Assessment information generated by the machine learning model.

### CROSS REFERENCE

The present application claims the benefit under 35 U.S.C. § 119 of German Patent Application No. DE 10 2024 201 985.2 filed on Mar. 4, 2024, which is expressly incorporated herein by reference in its entirety.

### FIELD

The present invention relates to devices and methods for verifying security and/or safety of technical systems.

### BACKGROUND INFORMATION

Technical systems which are deployed in a context where there are high requirements regarding security and safety, like for example electronic control units (ECUs) in a vehicle, need to be verified with respect to security and/or safety or, in other words, Threat and Risk Assessment (TARA) needs to be performed. A technical system may then be reconfigured (e.g. provided with security and safety measures such as error correction, firewall or redundancy) in case the verification shows that security and/or safety is insufficient for the respective use case. Since such an assessment (or verification) requires a high amount of manual labour and expert knowledge, efficient and reliable automated approaches are desirable.

### SUMMARY

According to various embodiments of the present invention, a method for verifying security and/or safety of a technical system is provided. According to an example embodiment of the present invention, the method includes receiving architectural information about the technical system, wherein the architectural information includes information about a hierarchy of the functional parts of the technical system, extracting keywords identifying functional parts of the technical system and, for each keyword, hierarchy information specifying a position of the functional part identified by the keyword in a hierarchy of the functional parts of the technical system, generating, for each keyword, an embedding of the keyword and its hierarchy information, feeding the generated embeddings to a machine learning model trained to generate Threat Analysis and Risk Assessment information for the technical system from the embeddings and verifying security and/or safety of the technical system using the Threat Analysis and Risk Assessment information generated by the machine learning model.

The above method of the present invention provides an efficient and reliable automated approach for verifying security and/or safety of a technical system, i.e., for performing Threat and Risk Assessment (TARA). In particular, usage of a machine learning model that is trained based on historical data allows including expert knowledge and the automatic extraction of keywords identifying functional parts allows automating a high amount of manual labour. Moreover, the inclusion of hierarchical information allows, similar to natural language processing which takes into account positions of words, taking into account interrelations between components and their sub-components and thus correctly identifying threats (e.g., by using a machine learning model using an attention mechanisms which operates on the embeddings, e.g. a transformer model).

In the following, various examples of the present invention are given.
Example 1 is a method for verifying security and/or safety of a technical system as described above.
Example 2 is the method of example 1, wherein the Threat Analysis and Risk Assessment information includes identifications of one or more security and/or safety threats and, for each security and/or safety threat a specification of a criticality of the security and/or safety threat.

The model may thus be trained to also predict a criticality level of a threat which may then be taken into account in the configuration of the technical system (e.g. threats with high criticality level may be prioritized when including security and/or safety mechanisms). Since via the machine learning model, expert knowledge may be included (via the training data, in particular when using a foundation model (e.g. pre-trained on a large amount of training data and then fine-tuned) as machine learning model), overall security and/or safety may thus be efficiently increased.
Example 3 is the method of example 1 or 2, wherein verifying the security and/or safety of the technical system comprises feeding the Threat Analysis and Risk Assessment information generated by the machine learning model to a Threat Analysis and Risk Assessment (TARA) software by means of an application programming interface (API) call of the Threat Analysis and Risk Assessment software.

Alternatively, a file (e.g. XML or JSON) containing the Threat Analysis and Risk Assessment information is generated (according to the TARA software's input data structure) which is input to or read by the TARA software. An API call may have the advantage that it may still be used in the same manner even if the Threat Analysis and Risk Assessment software is updated in a way that the format of its input data structure changes.
Example 4 is the method of any one of examples 1 to 3, comprising training the machine learning level by supervised learning using training data elements including training input examples and target Threat Analysis and Risk Assessment information.
Example 5 is an (automated) method for configuring (or controlling) a technical system (with respect to security and/or safety, i.e. in view of Threat and Risk Assessment), comprising verifying security and/or safety of the technical system according to any one of examples 1 to 4 and configuring the technical system taking into account a result of the verification.

For example, security and/or safety measures may be included when the verification shows insufficient results for certain functional parts or components of the technical system.
Example 6 is the method of example 5, comprising configuring the technical system with security and/or safety measures to mitigate security and/or safety weaknesses indicated by the Threat Analysis and Risk Assessment information.
Example 7 is a data processing system, configured to perform a method of any one of examples 1 to 6.
Example 8 is a computer program comprising instructions which, when executed by a computer, makes the computer perform a method according to any one of examples 1 to 6.
Example 9 is a computer-readable medium comprising instructions which, when executed by a computer, makes the computer perform a method according to any one of examples 1 to 6.

In the figures, similar reference characters generally refer to the same parts throughout the different views. The figures are not necessarily to scale, emphasis instead generally being placed upon illustrating the principles of the present invention. In the following description, various aspects are described with reference to the figures.

### BRIEF DESCRIPTION OF THE DRAWINGS

FIG. 1 shows a vehicle as an example of a technical system for which TARA should be performed.

FIG. 2 illustrates the processing flow of processing architectural information provided by a software (and/or hardware) modelling tool (i.e. architecture (modelling) software).

FIG. 3 shows a flow diagram illustrating an (automated) method for verifying security and/or safety of a technical system, according to an example embodiment of the present invention.

### DETAILED DESCRIPTION OF EXAMPLE EMBODIMENTS

The following detailed description refers to the figures that show, by way of illustration, specific details and aspects of this disclosure in which the present invention may be practiced. Other aspects may be utilized and structural, logical, and electrical changes may be made without departing from the scope of the present invention. The various aspects of this disclosure are not necessarily mutually exclusive, as some aspects of this disclosure can be combined with one or more other aspects of this disclosure to form new aspects.

In the following, various examples will be described in more detail.

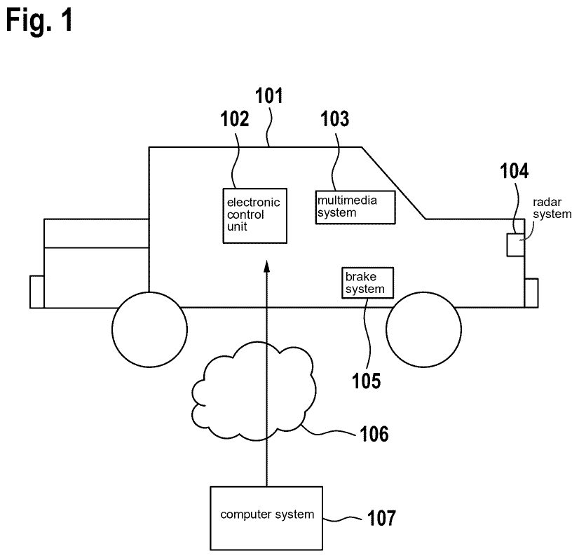

FIG. 1 shows a vehicle 101.

The vehicle 101, for example a car or truck, is provided with multiple components such as one or more vehicle control devices (also referred to as an electronic control unit, e.g. a control unit, e.g. an electronic control unit (ECU)) 102, a multimedia system 103, a radar system 104, a brake system 105 etc.

Typically, a TARA (Threat Analysis and Risk Assessment) needs to be performed for these components. For example, certain components need to be certified before a vehicle that includes them may be operated.

Components are typically realized by software running on a hardware device. The software is transferred, for example, from a computer system 107 to the vehicle 101, e.g. via a network 106 (or also with the aid of a storage medium such as a memory card). This can also be done during operation (or at least when the vehicle 101 is with the user), as the control software 107 is updated to new versions over time, for example.

According to various embodiments, by means of a computer system like the computer system 107, TARA is performed. For this, the computer system 107 receives information about the respective component, specifically one or more files describing its (software and/or hardware) architecture. The computer system 107 may then, depending on the TARA, allow usage of the components or change their configuration (deactivate functions (in particular interfaces or communication protocols), include additional security measures by updating the components' software (such as include a firewall) etc.).

It should be noted that this is typically not done individually per vehicle as shown in FIG. 1 but for a fleet of vehicles including the respective components. Further, this may also be performed before the components are installed in the vehicle 101.

Thus, according to various embodiments, for configuring a technical system (like the vehicle 101) with respect to security and safety risks and threats (i.e. in particular for performing TARA), the computer system 107 extracts architecture information (for the technical system as a whole or components thereof) using (architectural) files such as Extensible Markup Language (XML) files as a source for the information. Further, it may use a library of known attacks (e.g. attack trees) for performing TARA.

A vehicle may thus be made more secure and safe for the passengers as an automated extraction of architectural features lowers the possibility of manual human mistakes during the execution of the TARA. Further, by standardizing the TARA to a certain extent, common (human) mistakes in TARA can be eliminated. Moreover, the time to market for new automotive products can be sped up as the automation for TARA reduces design verification time. The approaches described herein may be applied to any products in the automotive sector including ECUs, brake systems etc. but also other technical systems such as manufacturing machines, any kind of robot, etc.

The architectural information may be provided by a software (and/or hardware) modelling tool (such as Enterprise Architect). This information is processed as described in the following to provide input for given TARA software.

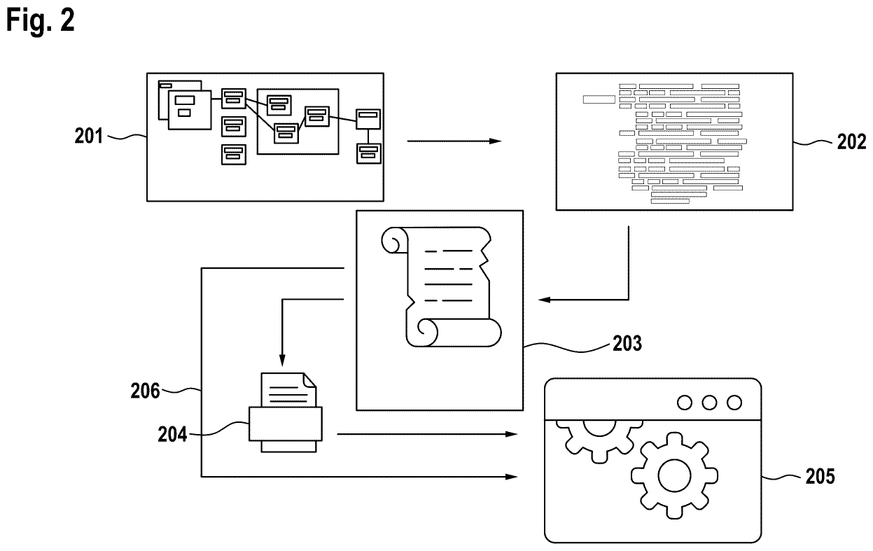

FIG. 2 illustrates the processing flow of processing architectural information provided by a software (and/or hardware) modelling tool 201 (i.e. architecture (modelling) software).

In the example of FIG. 1, the architectural information is exported from the modelling tool in the form of (i.e. by creating) an Extensible Markup Language (XML) or Unified Modeling Language (UML) file 202. This exported architectural information file 202 is then read by an (intelligent) parser 203, e.g. implemented by a parsing script, e.g. written in Python (which may however be a functional block of multiple processing blocks, in particular it may, as described below, include a machine learning model; it may therefore also be considered as parsing and mapping (of architectural information to TARA information) function or component). The parser 203 extracts the relevant information from the exported architectural information file 202 and uses this information to directly pre-fill a TARA data structure (e.g. form) 204 with TARA information readable by TARA software 205. The parser 202 is not only able to extract the architectural information (e.g. of a certain component), but also is aware of the context of the architectural information.

So, according to one embodiment, the automated steps to extract and fill in the TARA information are as follows:
Export file 202 from architecture software 201 in form of machine readable format.
Extract information from file 202.
Intelligently select relevant TARA information from extracted information.
Fill (or pre-fill) TARA fields of TARA data structure 204 for TARA software 205

In the following, the generation of TARA information on the basis of the exported file 102 (or files, also referred to as architectural file(s) in the following), i.e. e.g. the software flow of the parser 201, is described in more detail.
1. Search diagrams: the parser 201 first searches for diagrams in the file 202. It should be noted that this means that it searches for (markup-language) code in the file 202 (i.e. e.g. XML or UML expressions) in the file 202 since the file does not contain the diagrams as pictures showing diagrams but rather as markup language structures that represent diagrams from the original architectural information 201.

This is for example done by a function “find images” having as input an XML file and as output a list of diagrams and has the following flow
1.1 Input XMI file (e.g. XML file or UML file)
1.2 find package with string “Technical view” in its name the XMI file
1.3 Execute function “find leaves” having as input the package (as tree element) and a leaves list containing XMI IDs (of leaves) and as output a list of IDs of leaves of the tree element. The function “find leaves”
   recursively looks for (child) packages with in the input package
   if a child package is found recursively calls itself on child package
stops when no child package is found
Adds XMI ID of leaf package to leaves list
1.4 Iterate through diagrams of XMI file (e.g. UML diagrams), if package of diagram is in leaves list, add diagram name to list of diagrams
1.5 Output diagram list to extract elements

So, the parser 203 first searches for the term “technical view”. Technical view refers to the various views available in the architectural hierarchy. From this, the parser 203 recursively searches for packages and its corresponding child packages. This allows the parser 203 to iterate through all the diagrams and store each diagram's ID and location. By knowing the location, the hierarchy of the system is maintained. This allows performing data flow analysis in a later function block of the parser.

For example, the parser 203 finds within the category “system functions” and the sub-category ETS (Electronic Traction Unit) ECU diagrams for time synchronization of ECU CAN Slave and ECU Ethernet Slave, e.g. both for ETS as master and ETS as salve (e.g. arranged in different top categories like “vehicle” and “vehicle domain”). It finds these four diagrams in an expanded view of the architectural information and extracts them.
2. Map diagrams and extract keywords: In this functional block, the parser 202 extracts keywords from each of the extracted diagrams and maps them to their corresponding hierarchy level. There are two types of keywords, namely “asset” and “descriptive”. An asset keyword refers to commonly known interface components such as USB, CAN bus, SPI (serial peripheral interface) etc., which are referenced by a known library. The actual “asset” may refer to the configuration (e.g. configuration file) of a component wherein the configuration can be accessed via the interface. So, the presence of the interface poses a possible pathway to access the asset. The exact definition of an asset may differ between different Business Domains. Descriptive keywords include terms such as “ECU”, “messages”, “master” and “slave”. These keywords help forming the context of the system so that it is for example clear that a specific diagram is a child of a larger system such as radar (or ETS ECU in the above example).

For keyword extraction and diagram mapping the parser 203 first iterates through each diagram (the location is provided by the diagram searching function described above under 1) and searches for ID tags of different elements (e.g., connectors, ports, blocks, objects, and others) associated with it. The next step is to find each element and extract the keywords associated with that element. It then separates these keywords into asset keywords or descriptors keywords using a pre-defined library and stored in a dictionary. Finally, it includes the hierarchy to ensure the correct parent-child relationship among all the keywords.

The keyword extraction is for example performed by a function “Map Images” which includes the following (sub-) functions:
Function “Find Diagram Elements”
   Input: name of required diagram in string format
   Output list of IDs of elements in required diagram
   Iterates through all extracted diagrams to find one whose name matches
   Iterates through elements of found diagram and stores the elements ID in an element list
Function “Extract Keywords”
   Input: Name of required diagram in string format
   Output: dictionary of each element ID and the keyword it corresponds to
   Searches, for each element in the element list, through IDs of packages, classes, elements and attributes
   If ID matches, updates the dictionary with the ID as key and corresponding keyword as value
Function “Identify Assets”
   Input: dictionary of extracted keywords
   Output: updated dictionary in which dictionary is tagged as descriptor or asset
   Compares each extracted keyword of the input dictionary to a pre-defined asset list
      if match, the keyword is tagged as asset
      else keyword is tagged as descriptor
Function “Assign Hierarchy”
   Input: Dictionary of extracted keywords
   Output: updated dictionary separating descriptors and assets found in the diagram
   Iterates through keywords in the dictionary
   Within the relevant XMI tag, if another dictionary keyword is found, the correct hierarchy is assigned between the two descriptors or assets
3) Mapping of keywords to threats: In the following, two approaches for the (intelligent) threat mapping will be described.
   Natural Language Processing (NLP) approach: first, the keywords which include both assets or descriptors are fed into a stop word filter as pre-processing. This filter removes non-relevant words such as prepositions and adjectives, which are referenced from a known library. After filtering, the keywords are tokenized in order to assign them values for processing by a NLP model (which can be considered as part of the parser 203). The hierarchy information that is associated with each keyword is then stored as positioning values. So, in contrast to traditional NLP which encodes the position of words (or tokens) within a sentence, the hierarchy information gives the “position” information which is encoded (since there are only keywords but no sentences to extract positions). Next, each token and its position information are combined into an embedding, which vectorizes both token and position information and finds similarities between pairs of keywords (taken into account position). In a training phase of the model past TARA files (i.e. pre-determined target (i.e. ground truth) TARA information for training input examples) are used for training. The TARA files provide keywords that are then matched with the embeddings in order to find the relationships between TARA fields (of the TARA data structure 204) and embeddings. The model is for example trained to predict threats and/or ways of mitigating the threats. It may also take into account the criticality of the respective component (or function). For example, a USB port in a radar system has greater security risk than a 3rd party infotainment system that is not connected to the car controls. Thus the model may be trained to predict one of different threat (i.e. criticality) levels for a given component and corresponding mitigation measures (e.g. in the form of an entry of a field in the TARA data structure). For inference (using the trained model), the keywords are fed into the pre-processing step and the embeddings are input to the trained model. The output is then information for the entries for the corresponding TARA fields to be (pre-) filled in the TARA data structure 204 of the TARA software 205.
   Perform one-shot inference using a fine-tuned foundational model (which can be considered as part of the parser 203): this approach assumes that a foundational model is available. The keywords (with their positional information) are first fed into the stop words filter, similar to the NLP approach. This ensures that non-useful words are not being fed into the foundation model to save on computation effort. The filtered keywords are then fed into a prompt generator which is used to query the foundational model. The output of the model is the predicted predicted information for the fields of the TARA data structure.
4) Translation to TARA software input format: once the architectural information has been mapped to the TARA information (e.g. threat information), the next step is to translate the information into a format that is readable by the TARA software 205 (i.e. into the TARA data structure 204 of suitable form). The TARA data structure 204 is can be in a form of JSON (JavaScript Object Notation) or XML files, that is machine readable. A drawback of using this format is that the data structure might change in case of a TARA software update that affects format versions, which may cause the translation (from architectural information to TARA information, i.e. to TARA software input information) to fail. Therefore, as an alternative, API calls 206 may be used for inputting the TARA information into the TARA software 205 if that is supported by the TARA software 205. This approach ensure that the translation is up to date. (These two approaches are shown as the two parallel paths FIG. 2).

Then, the technical system (e.g. vehicle components) are configured according to the results given by the TARA software like for example security and/or safety mechanisms are included (like encryption, redundancy etc.) or certain functions are restricted (e.g. access rights for unsecure components to other components are restricted, control functionalities are blocked etc.)

So, according to various embodiments,
architecture information is automatically parsed from a machine-readable format such as XML and UML
hierarchy information in the architecture information is preserved during extraction
keywords are mapped to using NLP to improve correctness
by using a (pre-trained) foundational model expert knowledge may be incorporated
approach is not limited to any industry or domain and can be applied to both software and hardware as long as an architecture is defined.

So, the parser (e.g. parsing script) 203 (which also includes a mapper, i.e. mapping functionality as described above) gets the architectural information in the XML/UML file 202 and extracts the information (about threats and criticality) which is input to the TARA software 205 by filling up fields of a data structure or file 204 that the TARA software 205 uses or gets as input und contains Threat Analysis and Risk Assessment information. Alternatively, the Threat Analysis and Risk Assessment information is fed into the TARA software 205 by one or more API calls.

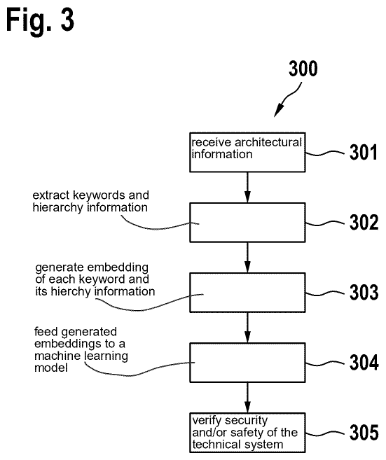

In summary, according to various embodiments, a method is provided as illustrated in FIG. 3.

FIG. 3 shows a flow diagram 300 illustrating an (automated) method for verifying security and/or safety of a technical system.

In 301, architectural information about the technical system (i.e. including description of functional parts of the technical system (like interface function such as Ethernet slave, CAN Slave or larger functional parts like an ECU of a vehicle) etc.), including diagrams (with text, e.g. in XML representation)) is received, wherein the architectural information includes information about a hierarchy of the functional parts (i.e. which functional parts implement parts (sub-functions) of other functional parts such as an ECU has an CAN slave or Ethernet time synchronization is one sub-function of ECU time synchronisation) of the technical system (e.g. in the form of a file like an XML or UML file).

In 302 keywords identifying functional parts of the technical system are and, for each keyword, hierarchy information specifying a position of the functional part identified by the keyword in a hierarchy of the functional parts of the technical system are extracted.

In 303, for each keyword, an embedding of the keyword and its hierarchy information is generated (i.e. encoding the keyword and its hierarchy information (e.g. concatenated together to an input of an encoder, e.g. a machine learning-based encoder model such as the encoder of a transformer network (like of a large language model) where instead of positional information the hierarchy information is used) to an embedding.

In 304, the generated embeddings are fed to a machine learning model trained to generate Threat Analysis and Risk Assessment information for the technical system from the embeddings.

In 305, security and/or safety of the technical system is verified (i.e. checked) using the Threat Analysis and Risk Assessment information generated by the machine learning model.

The approach of FIG. 3 can be used to configure various types of technical systems (with respect to security and/or safety), like e.g. a computer-controlled machine, a robot, a vehicle, a domestic appliance, a power tool, a manufacturing machine, a personal assistant or an access control system and individual components thereof (e.g. in case of a vehicle an ECU, a radar device, a multimedia device or system etc.).

The method of FIG. 3 may be performed by one or more data processing devices (e.g. computers or microcontrollers) having one or more data processing units. The term “data processing unit” may be understood to mean any type of entity that enables the processing of data or signals. For example, the data or signals may be handled according to at least one (i.e., one or more than one) specific function performed by the data processing unit. A data processing unit may include or be formed from an analogue circuit, a digital circuit, a logic circuit, a microprocessor, a microcontroller, a central processing unit (CPU), a graphics processing unit (GPU), a digital signal processor (DSP), a field programmable gate array (FPGA), or any combination thereof. Any other means for implementing the respective functions described in more detail herein may also be understood to include a data processing unit or logic circuitry. One or more of the method steps described in more detail herein may be performed (e.g., implemented) by a data processing unit through one or more specific functions performed by the data processing unit.

Accordingly, according to one embodiment, the method is computer-implemented.

What is claimed is:

1. A method for verifying security and/or safety of a technical system, comprising the following steps:
receiving architectural information about the technical system, wherein the architectural information includes information about a hierarchy of the functional parts of the technical system;
extracting keywords identifying functional parts of the technical system, and, for each keyword of the keywords, hierarchy information specifying a position of the functional part identified by the keyword in a hierarchy of the functional parts of the technical system;
generating, for each keyword, an embedding of the keyword and the hierarchy information of the keyword;
feeding the generated embeddings to a machine learning model trained to generate Threat Analysis and Risk Assessment information for the technical system from the embeddings; and
verifying security and/or safety of the technical system using the Threat Analysis and Risk Assessment information generated by the machine learning model.

2. The method of claim 1, wherein the Threat Analysis and Risk Assessment information includes identifications of one or more security and/or safety threats, and, for each security and/or safety threat a specification of a criticality of the security and/or safety threat.

3. The method of claim 1, wherein the verifying of the security and/or safety of the technical system includes feeding the Threat Analysis and Risk Assessment information generated by the machine learning model to a Threat Analysis and Risk Assessment software using an application programming interface call of the Threat Analysis and Risk Assessment software.

4. The method of claim 1, further comprising:
training the machine learning level by supervised learning using training data elements including training input examples and target Threat Analysis and Risk Assessment information.

5. The method of claim 1, further comprising configuring the technical system taking into account a result of the verification.

6. The method of claim 5, further comprising configuring the technical system with security and/or safety measures to mitigate security and/or safety weaknesses indicated by the Threat Analysis and Risk Assessment information.

7. A data processing system configured to verifying security and/or safety of a technical system, the data processing system configured to:
receive architectural information ABOUT the technical system, wherein the architectural information includes information about a hierarchy of the functional parts of the technical system;
extract keywords identifying functional parts of the technical system, and, for each keyword of the keywords, hierarchy information specifying a position of the functional part identified by the keyword in a hierarchy of the functional parts of the technical system;
generate, for each keyword, an embedding of the keyword and the hierarchy information of the keyword;
feed the generated embeddings to a machine learning model trained to generate Threat Analysis and Risk Assessment information for the technical system from the embeddings; and
verify security and/or safety of the technical system using the Threat Analysis and Risk Assessment information generated by the machine learning model.

8. A non-transitory computer-readable medium on which are stored instructions verifying security and/or safety of a technical system, the instructions, when executed by a computer, causing the computer to perform the following steps:
receiving architectural information about the technical system, wherein the architectural information includes information about a hierarchy of the functional parts of the technical system;
extracting keywords identifying functional parts of the technical system, and, for each keyword of the keywords, hierarchy information specifying a position of the functional part identified by the keyword in a hierarchy of the functional parts of the technical system;
generating, for each keyword, an embedding of the keyword and the hierarchy information of the keyword;
feeding the generated embeddings to a machine learning model trained to generate Threat Analysis and Risk Assessment information for the technical system from the embeddings; and
verifying security and/or safety of the technical system using the Threat Analysis and Risk Assessment information generated by the machine learning model.
